(19) United States
(12) Patent Application Publication
(10) Pub. No.: US 2021/0004875 A1
(43) Pub. Date: Jan. 7, 2021

(54) Brand Online Content Dissemination to Retailer Social Media Outlets

(71) Applicant: ThumbStopper, Tampa, FL (US)

(72) Inventors: Matthew Brown, Tampa, FL (US); Scott Demarco, Valrico, FL (US); Kelcey Morgan, Tampa, FL (US)

(21) Appl. No.: 16/432,907

(22) Filed: Jun. 5, 2019

Related U.S. Application Data
(60) Provisional application No. 62/680,532, filed on Jun. 4, 2018.

(51) Int. Cl. G06Q 30/02; G06Q 50/00; H04L 9/32; G06F 16/958

(52) U.S. Cl. CPC G06Q 30/0277; G06Q 30/0276; G06F 16/958; G06Q 50/01; H04L 9/3213; G06Q 30/0253

(57) ABSTRACT

A service provider operates between a Brand and multiple Retailers, establishing a relationship between them and enabling the flow of content between the Brand and the Retailers, specifically to social media outlets of the Retailers. The service provider is used by either the Brand or the Retailer. The service provider links Brand content with multiple Retailer social media sites while taking into consideration preferences, settings, and requirements of the Retailers. The digital assets of the Brand are automatically posted in a randomized manner to the multiple Retailers such that a Retailer does not have to expend resources or time to have such postings made to its social media sites.

### CROSS-REFERENCE TO RELATED APPLICATIONS

This application claims the benefit under 35 U.S.C. § 119(e) of U.S. Provisional Patent Application No. 62/680,532, filed on Jun. 4, 2018, which is incorporated by reference herein in its entirety for all purposes.

### BACKGROUND

### 1. Field

The invention relates to creating commercial relationships between entities on the

Internet and disseminating and creating content flow between the entities using software. More specifically, it relates to software for creating flow of social media content from one entity to another entity over the Internet in an automated, curated, and randomized manner for commercial and business purposes.

### 2. Related Art

An active, current, online social media presence has become increasingly important if not essential for many types of businesses. To stay competitive, retailers and other businesses, such as OEM, wholesalers, corporations, and other entities in the supply chain, collectively referred to as “Brands”, must engage customers and potential customers online and this is often done through retailers who sell that Brand's products. Many businesses, regardless of size, have difficulty (a) maintaining their online presence and (b) providing content that is interactive, interesting, and current. In addition, providing a relevant online presence can be expensive, if not unaffordable for smaller companies. Even when the investment is made, many companies struggle to find staff with the appropriate skills to efficiently curate content.

On the other side of the equation, there is a wide range of Brands that must be aware of and should actively maintain their social media presence. However, embodiments in this application focus on content flowing between what is referred to as Brands and Retailers. On one side, there are Brands that have multiple Retailers, storefronts, franchises (of the Brand or of others), and locations (referred to collectively as “Retailers”). More specifically, embodiments herein focus on the relationship between a Brand and a Retailer and the flow of social media content between the two facilitated by a service provider.

It is useful to note that in the Brand/Retailer model, a Brand may have multiple Retailers that the Brand does not own or control. An example of this model is where Ford Motor Company is a Brand and the individual Ford dealerships are the Retailers. A sample of industries served by the Brand/Retailer model include, but is not limited to: Automotive; Power sports; Recreational Vehicles (RV); Marine; Outdoor power equipment; Furniture; Home Goods; Pools; Electronics; Medical; Food and beverage; Education and schools; Hospitality; Service Industries; Jewelry and watches; Sporting and gym equipment; and Clothing manufacturers.

In the Brand/Retailer model, the Brand often makes large financial investments in creating or producing relevant, interesting, and dynamic content for Retailers' social media pages (such as Facebook, Instagram, Twitter, YouTube, Snapchat, etc.). This content can vary from event promotion to high-production video ads. However, currently Brands do not have solutions to get this valuable content to the Retailers' social media sites or their official web sites in an organized and timely manner. Retailers, on the other hand, often cannot afford a full-time social media manager and even struggle to provide consistent updates to their social media pages. Therefore, although both Brands and Retailers want Brands' content on Retailers' social media sites, the process is manual, sporadic, and labor intensive. As noted, the above problem is particularly acute for Brand/Retailer models where the Brand does not own the Retailers. However, even distributing content to Brand-owned or managed Retailers can be a labor-intensive process.

Additionally, a Brand needs to ensure that their Brand messaging, integrity, and good will, is maintained within their Retailer's representation of the Brand. This on-brand messaging and consistency of Brand representation is extremely difficult, if not impossible, to control and manage within the current Brand/Retailer model, as described above.

What is needed is an efficient methodology and platform for creating a relationship between a Brand and a Retailer in which the Retailer understands what the Brand can provide and the Brand understands what the Retailer needs. Once established, what is needed is an automated yet highly customizable platform that enables multiple types of operations for distributing Brand content to a Retailer's social media outlets.

### SUMMARY

One aspect of the present invention, a service provider or intermediary operates, broadly speaking, between a Brand and Retailer, establishes their relationship and enables the flow of content between the two, specifically to social media outlets of the Retailer. The service provider is used by either the Brand or the Retailer. Other types of businesses may also have use of the service provider; however, the Brand/Retailer model is used to illustrate various embodiments of the present invention. In one embodiment, the service provider links Brand content with multiple Retailer social media sites, including the Retailer's official website, while taking into consideration preferences and requirements of the Retailer.

One aspect of the present invention discloses a platform or system which allows for several advantages: Brands' content to be easily posted to a multitude of social media outlets maintained by the Retailers; maximizing the Brand's marketing reach by leveraging its Retailer social media networks; providing a professional, product-specific experience for each Retailer's social media networks; providing Retailer assurance that their online presence is being expertly curated, managed, and scheduled in a manner that is tailored to the Retailers' customer base; producing content to attract new customers, in addition to creating good will and being socially engaged with its community which increases revenue and profitability for both the Brand and the Retailers; accomplishing the above without having to use valuable staff time for either the Brand or Retailers; Organizes, posts, and paid promotes Brand/Retailer campaigns for time-sensitive promotions, events, or product releases; and Maintains Brand integrity and messaging throughout the social networks of distribution.

### BRIEF DESCRIPTION OF THE DRAWINGS

FIG. 1 is a flow diagram of a process for onboarding a Brand from an operations perspective in accordance with one embodiment;

FIG. 2 is a flow diagram illustrating the Brand onboarding process from the perspective of Brand marketing in accordance with one embodiment;

FIG. 3 is a flow diagram of a process of onboarding a Retailer to the service provider platform in accordance with one embodiment; and

FIG. 4 is a block diagram of a data processing system in accordance with one embodiment.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting. On the contrary, it is intended to cover alternatives, modifications, and equivalents as may be included within the spirit and scope of the described embodiments as defined by the appended claims.

In one embodiment, the platform allows for several advantages: Brands' content to be easily posted to a multitude of social media outlets maintained by the Retailers; maximizing the Brand's marketing reach by leveraging its Retailer social media networks; providing a professional, product-specific experience for each Retailer's social media networks; providing Retailer assurance that their online presence is being expertly curated, managed, and scheduled in a manner that is tailored to the Retailers' customer base; producing content to attract new customers, in addition to creating good will and being socially engaged with its community which increases revenue and profitability for both the Brand and the Retailers; accomplishing the above without having to use valuable staff time for either the Brand or Retailers; Organizes, posts, and paid promotes Brand/Retailer campaigns for time-sensitive promotions, events, or product releases; and Maintains Brand integrity and messaging throughout the social networks of distribution.

As noted, a service provider or intermediary operates, broadly speaking, between the Brand and Retailer, establishes their relationship and enables the flow of content between the two, specifically social media outlets of the Retailer, described in detail below. The service provider is used by either the Brand or the Retailer. Other types of businesses may also have use of the service provider; however, the Brand/Retailer model is used to illustrate various embodiments of the present invention. In one embodiment, the service provider links Brand content with multiple Retailer social media sites, including the Retailer's official website, while taking into consideration preferences and requirements of the Retailer.

The inventive aspect begins with establishing a relationship between the Brand and the service provider. A relationship is also established between the service provider and the Retailer. Embodiments of the present invention describe what can be characterized as commercial relationships between business entities and the improved efficiency and scale with which these relationships are forged and the manner in which content flows between the entities. As such, the inventive concepts have a foundation in business processes and may have practical applications in a number of market sectors. For the purposes of illustration only, outdoor equipment and recreational equipment Brands and Retailers are used to describe various embodiments.

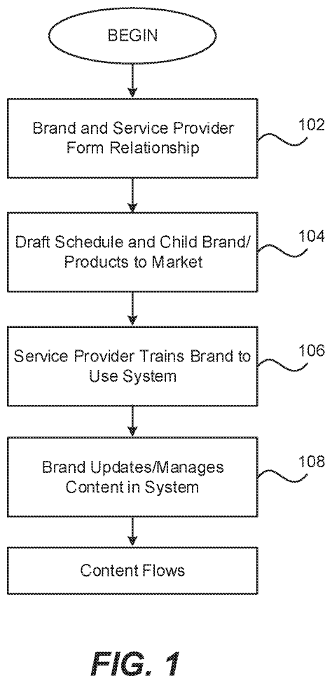

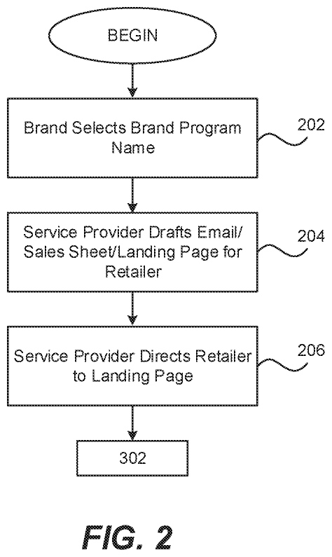

FIGS. 1 and 2 are flow diagrams showing processes of establishing a relationship between a Brand and the service provider in accordance with one embodiment. There are two aspects of establishing this relationship, also referred to as onboarding. One is from a Brand operations perspective shown in FIG. 1. The other is from a Brand marketing perspective shown in FIG. 2.

FIG. 1 is a flow diagram of a process for onboarding a Brand from an operations perspective in accordance with one embodiment. It shows steps that may occur when the service provider and Brand, sometimes referred to as parent Brand if there are child

Brands, initially create a business relationship. At step 102 the Brand and the service provider engage with each other with the business objective of the service provider providing software and processes so the Brand can automate the process of providing promotional content and other digital assets online to Retailers which sell Brand products or child Brand products. This is conventionally done by entering a contract or agreement.

Once the relationship has been established, at step 104 the service provider drafts a schedule for releasing Brand products, in some cases, child Brand products, to market. This schedule contains a timetable that the Brand would like the service provider to take into account when disseminating Brand content to Retailers. At step 106 the service provider trains the Brand to use the service provider platform or system. The social media program that is created and implemented by the service provider system should be looked at and should appear to Retailers as a Brand program (as opposed to a service provider program) and thus it is important for Brand personnel to know how to use the program.

At step 108 the Brand updates and manages its high-quality digital assets in the service provider system. At this stage the service provider ensures that the Brand life style and product content is disseminated to Retailers in a manner such that Retailers receive only relevant content, as defined by Retailer settings, and that is randomized so that Retailers' social media postings appear individually curated rather than coordinated, automated, or synchronized with similar Retailers. An important objective is for the content, although professionally curated by the Brand, to appear at different times for multiple Retailers instead of the same content being posted to each of the Brand's Retailers simultaneously, thus the randomization feature described above is important in creating a native posting appearance. This has the additional advantage with some social media sites, most notably Facebook which treats native postings favorably and thus more likely to increase engagement with Retailer customers. As noted above, the content may directly from the Brand or may come from trusted public, industry-related sources and affiliated sites. The content may also come via RSS feeds from the Brand's own social media sites.

FIG. 2 is a flow diagram illustrating the Brand onboarding process from the perspective of Brand marketing in accordance with one embodiment. At step 202 the Brand marketing department or other appropriate department selects a Brand program name. This is the name that the Brand will use for promoting its new Retailer-oriented social media content service. For example, the Brand, Super Speed Motorcycles, may name its program Super Speed Social Flow Program. At step 204 the service provider creates drafts of emails and other messaging that will be sent to Retailers on behalf of the Brand or sent to Retailers directly by the Brand. In addition to email introducing the Retailer to the service provider, there may also be a sales sheet that provides details and generally promotes the social media program. In the earlier example, the sales sheet would provide details on what the Super Speed Social Program would do for Retailers' social media sites. It could mention things such as increased visibility, staying consistent with the Brand and messaging, increased awareness and engagement with social media, and other beneficial marketing factors for the Retailer. In the email or sales sheet, there may also be an active link to the Program sign-up page, essentially a micro-website, which the Retailer can visit by clicking on. The Program sign-up page is created by the service provider for the Brand social media program. The Retailer is directed to the sign-up page at step 206.

At this stage the Retailer has expressed interest (shown by clicking on the link) in receiving high-quality digital assets and other content from the Brand to its social media sites via the service provider platform. Once at the Program sign-up page (e.g., Super Speed Social Program sign-up page), the Retailer may make a series of selections regarding what content it would like to receive and the manner in which it receives it. These selections ensure that its social media sites receive only relevant content from the

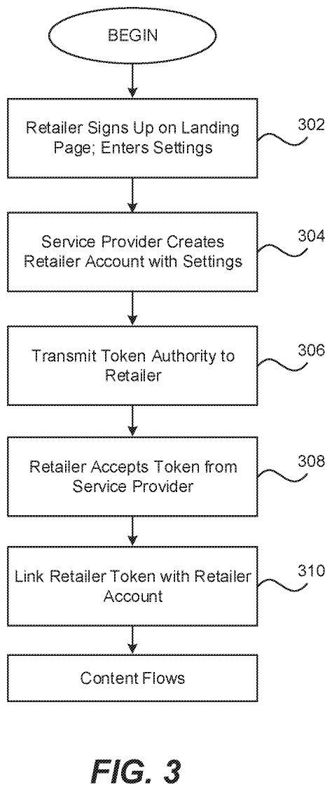

Brand. After a Retailer completes step 206, it is officially signed up for the Program and the process continues for the Retailer shown in FIG. 3.

FIG. 3 is a flow diagram of a process of onboarding a Retailer to the service provider platform in accordance with one embodiment. The process picks up after step 206 where the Retailer has visited and completed signing up on the Program sign-up page. At step 302 the Retailer begins entering data and making selections which collectively lay out the parameters of what Brand content the Retailer wants to receive. These parameters may include a wide array of variables, including but not limited to frequency of posts, time of day, regionality, language, child Brand products, which social media sites, and the like. The service provider may also research the Retailer's web site and social media sites and make recommendations for settings and include them in the Program sign-up page for a specific Retailer. Once the Retailer has made selections for these settings, at step 304 the service provider creates a commercial relationship with the Retailer (e.g., by entering into a contract or agreement) and the service provider creates a

Retailer account within the service provider's software based on the settings and other information. The account has basic information on the Retailer; however, the level of specificity as to the type of Brand content it receives can vary. A Retailer (e.g., a large sporting goods chain) may cast a wide net and want to receive promotional content on several (or all) of Brand's products. Or the Retailer may be an independently-owned surf shop and specializes in niche products and wants only content on certain products at specific times and frequency, taking into account, for example, the sophistication of its customers and online audience. In any case, the service provider provides wide latitude in how the Retailer receives Brand content and when it receives it.

At step 306, once the Retailer account has been established, the service provider proceeds with obtaining authority to manage content on the Retailer social media sites. The first step in enabling this process is establishing an encrypted authorization token, one for each of the Retailer's social media pages. A token, which is distinguishable from and more secure than a conventional user name and password, is combined with the service provider's token for accessing a Retailer's social media page. Each distinct social media site has a separate token. The Retailer accepts the token authorization request as arranged by the service provider at step 308 thereby making the service provider a conduit for managing Brand content on the Retailer's social media sites in accordance with the Retailer's preferences and specifications. Neither the Brand nor the service provider has authority to make other changes to the Retailer's sites. Of course, the

Retailer still has ultimate authority to make changes to the sites, but through a token for each social media site, the Retailer has given the service provider and/or Brand (as authorized marketing partners) sufficient authority for them to carry out the business objectives as agreed to by the Retailer. A Retailer may revoke any or all tokens for its social media sites at any time, thereby permanently or temporarily suspending services from the service provider and postings from the Brand. In addition to the primary business objective of posting high-quality digital assets to the Retailer's social media sites, the Retailer or Brand may request that the service provider provide assistance or automation with respect to posting advertisements and managing calendars or managing business information (e.g., posting a change in business hours for the Retailer).

At step 310 the service provider links the token with the Retailer account. Once this is done, Brand content can start flowing to Retailer social media sites based on the settings selected by the Retailer. An important feature of the flow of digital assets from the Brand library stored by the service provider is the control over Brand integrity. Postings must always maintain a Brand's goodwill and be genuine and authentic. Ensuring this integrity is a critical aspect of the business relationship formed between the Brand and the service provider as shown in step 102. If content was disseminated and postings to social media sites contained erroneous content or besmirched the Brand in any manner, the service provider system can immediately redact, withdraw, scrub, or delete that content from all sites where it was posted.

The service provider system allows a Brand to widespread delete postings that may have been distributed inappropriately using a “redact” feature. This redact feature audits all Retailers who have received a post on their social media sites and automatically pulls it down from the social media site without the Brand needing to individually edit every retailer's postings. A Brand may choose to redact a post due to misspellings, off-brand content, imagery requirements, and other reasons.

After the on-boarding of the Retailer and Brand, the service provider obtains online content to timely and accurate posting of the content on social media outlets on behalf of a Retailer.

In one embodiment, the service provider aggregates Brand content. First, content is identified. A content item is anything that is either visual, audible, textual or a combination thereof in a digital format that can be disseminated over the Internet. They include, but are not limited to, articles, ads (banner, micro, etc.), pictures, videos, URLs or links, blog entries, texts, and the like. The source of brand content for the Brand Manager invention comes from various sources:
1. Content originating from the Brand and/or the Brand's Digital Media Agency of record;
2. Public content and/or User Generated Content (UGC) that is relevant or related to the Brand's products (for example, a video of an individual showing off the features of a brand's side-by-side powersport vehicle); and
3. Digital feeds from the Brand owned social media sources

Specific examples of Brand content include the following: Manufacturer A is a snowmobile Brand who sometimes puts on free outdoor events whereby people can try out snowmobiles, introduce new accessories, give away free sample items, have free food, music, and the like. Manufacturer A sends pictures, links, videos, and other content to the public, including Manufacturer A dealerships (or “Retailer”). The Retailers near the location of this event now want to publicize this event to its customers and, more generally, to the local community with the goal of getting new customers and building good will. Further, the Retailers need to disseminate or post this content out on Friday afternoon under its name so that their customers and their other social media followers will see it. Manufacturer B introduces a new line of speed boats and is showing the features off in videos. This is relevant and professional content to be delivered to Manufacturer B's dealerships' social pages that carry this new line of speed boats. Manufacturer C has a lifestyle blog that is engaging for their customer base community. The content being posted to their Retailers' social media pages helps to increase local conversation and engagement.

Once the service provider has possession of the Brand's digital assets (content), it begins the modification and pre-processing phase. Before the pre-processing phase is described, it should be noted that not all the pre-processing steps discussed below may be utilized or implemented for every content item. Some steps may be skipped; some steps may be modified; and other steps may be added. Part of it will depend on efficiency, speed, applicability, utility, and the type and details of the content. Also, the order in which the steps are done or how an item is pre-processed may vary as well. Not all steps are done in the same order for all content items. The objectives of the present invention of managing Brand content for a Retailer may be achieved with a subset of the steps described below performed in different sequences. It is also helpful to note that the purpose and utility of each pre-processing step may be mentioned but is described in more detail in the discussion of Retailer onboarding; automatic intelligent posting processes; and determining individual Retailer settings.

Sources are used in methods of inputting content from the Brand, public feeds, and Brand-owned social media sites. The types of sources may include but are not limited to custom content, Brand-affiliated social media sites, and public industry-related channels. Custom content is generally supplied directly into the Brand Manager by the Brand or an agency of record for the Brand. Brand-affiliated social media sites include content pre-populated into the Brand Manager via, for example, RSS feeds from Brand social media sites including but not limited to YouTube, Facebook, Instagram, and others. Public industry-related channels typically contain affiliated content from trusted industry sites, blogs, and social media sites directed to the service provider by the Brand.

A parent Brand may choose to use the service provider to deliver content to retailers that carry multiple child Brands of the parent Brand. The ability to distinguish the Brand affiliation for the content to a child Brand tier, if applicable, allows for multi-tier Brands to utilize a single system for content management and proper Retailer distribution.

Under the Brand level, the Retailer may only want content for specific products and/or features that are applicable to the Retailer's location. For example, a Brand manufactures both personal watercraft and motorized boats but the Retailer only carries personal watercraft at the Retailer's specific store.

Other pre-processing steps include assigning a date to the content item. In one embodiment, this is the date the content item becomes available for publishing, which may be the original source publication date, such as the date that an article was published or the date a video or photo was first placed online. Date information may also include the date the content item was originally created (which in many cases is earlier than the publication date). There may also be applicable dates around the content being applicable for posting online. For instance, Manufacturer A has a sale from April 20^{th}-April 30^{th} and wants the content for the promotion to go live on Retailer pages on April 20^{th} and/or any date between April 20^{th} and April 30^{th} only.

Another descriptor attached to a content item relates to geography and/or Brand-defined regionality. A content item, depending on what type of media the item is and whether geography is applicable or makes sense, can have a region or geographical area associated with it. Not all products and services have regional relevance. However, products that are regionally relevant are tagged as such. For example, snow mobiles in Florida will generally never make sense. In another embodiment, this can be done by examining zip code if one is available with the content item. Using a zip code or other regional identifier, the system can assign a state, city, town, county, or region associated with the content item. In many cases, the item will have a state or region (e.g., southwest, northeast, etc.) assigned to it. In other instances, a geographic region may not be assigned (e.g., a general article on safety when using all-terrain vehicles or a video showing highlights of extreme sports, etc.).

In one embodiment, regionality may be two-tier within the service provider and allows for both geographical region and state-levels to group content and a have Brand-defined regionality function, such as regions defined by distributor assignment or territory manager.

Content can also be provided in multiple languages. It is important for the Brand to be able to ensure delivery, for example, French copy for a piece of content to the Retailer's who have selected French as their preferred language within their Retailer on-boarding process descried above.
1. The platform may consider trending content of two types: (a) internally trending content and (b) externally trending content. Internally trending content is content posted by the invention that generates significant attention (such as “likes” in Facebook). If the platform determines that internal content posted by the invention is “trending,” then this content will be given a higher weight in posting for other Retailers. While nearly all of the prior pre-processing steps have an objective or factual basis, this one is subjective and is often fleeting or shifting. Also, another unique feature of internal trending is that this step is only performed after content is posted elsewhere in the system.
2. In another embodiment, the system will also track external trending. This is characterized as content that is relevant to the Brand or Retailer and is “top trending” content on the internet. It is likely that most content items obtained by the system will not qualify as top trending, but some content will, and it is important with respect to curating an entity's online presence and customer engagement, to be aware of such content. Like internal trending, external trending also is subjective and is often fleeting or shifting. However, if present, it is a critical component in the weighing of factors performed later in determining what may become part of the Retailer's social media presence.
3. Once the platform organizes the above data, it may automate the combination and organization of the data and examine the collective results. The system will then assign a relevance value to the content, referring to the categories described above. If the relevance value for a content item in a defined category is notable or warrants attention, it may be characterized as a “top trending” content item and, as noted, this plays a role in the automatic intelligent posting process. After pre-processing is done, the service provider may create a suitable, descriptive, and engaging title for the content or asset. This may not be done with all content items. The asset is then stored in the service provider repository from where it can be selected and posted to the Retailer social media sites.

As described above, the Retailer is onboarded and during this process the Retailer's preferences are identified. The service provider operates the system to manage and curate Brand content for the eventual distribution to the Retailers' social media pages. In this context a Retailer may be a power sports dealership, a home goods retailer, or an electronics retailer, to name a few examples. In this process the service provider gathers data about the Retailer, as described in the onboarding process above.

The service provider interviews the Retailer to collect some basic information about the Retailer and detailed information on the Retailers' social media needs and objectives. The service provider may also conduct its own inquiry into the new Retailer by going to the Retailer's website and/or social media pages to identify brands, vendors, product lines, services, location, etc. This may also be done through the Retailer sign-up form on-line which could include a survey section or selection list for Retailer to self-identify their preferred and applicable content. Other information obtained in this process may include items such as posting frequency, regionality, relevant brands and products carried by the Retailer, Retailer social media sites, and language preferences. Posting frequency may include, for example, a preferred number of posts each day and preferred time may include which days of the week to post and/or time of day to post. The information the service provider gets from the Retailer is used to establish Retailer settings in the system.

Another setting for a Retailer may be brand priority. For example, if the Retailer is a home goods Retailer, maybe it specializes in furniture and home accessories from a particular company and does not deal with or carry goods from other companies. This information can be used to prioritize the brands for the Retailer.

Another item of data is the social media outlets, that is, which of the growing number of social media channels does the Retailer want to post content items to. Some are commonly known, and others may be more specialized and have a narrower audience. In either case, the service provider will obtain specific site or platform names and addresses, blogs, messaging boards, and so on, from the Retailer. Most will include Facebook, Twitter, Instagram, YouTube, LinkedIn, and the like.

As described above, the service provider also obtains administrative approvals from the Retailer (reference to tokens above), which allows the Retailer to maintain control over its social media accounts while allowing the service provider the ability to make hands-free posts on the Retailer's behalf. As can be seen, there is a deep process of onboarding a Retailer and Brand. With respect to the Retailer, the better the service provider, which may be characterized as an intermediary, understands the Retailer, the better it can manage the Retailer's online presence effectively.

Once the Retailer has been onboarded, the system can begin managing the Retailer's social media presence by automatically and intelligently posting content to social media outlets via the Retailer's token. The process matches the modified Brands' content with the on-boarded Retailer preferences. Recall that a content item may be one or a combination of various types of media. To illustrate one embodiment, processes of how the system posts a single content item to one or more social media outlets for one Retailer are examined. In actual implementation, multiple content items (e.g., thousands of content items) are processed for multiple Retailers, in the scale of hundreds for example, concurrently. It also receives, collects, or in some manner obtains thousands of content items concurrently.

In one embodiment, content items are filtered using brands/product preferences, dates, regionality, languages, trending, and other factors that determine relevance of each content item. For example, a content item may have a regionality tag that does not match the Retailer's regionality assignment and thus would be filtered out. Generally, all objective, factual meta-data associated with the content item is processed by an algorithm considering some or all of the Retailer settings. Often, after the above filters are applied, most of content has been eliminated, leaving just a subset of truly relevant items. Of the content that remains, the system determines the piece of content that will be posted to the Retailer's social media sites on that given posting day.

As part of the automatic intelligent posting process, the system may first check if the Retailer has a schedule or preferred timing of when content items should be posted (including how many posts per day and what time of day to make posts). In addition to regularly scheduled content determined by the Retailer, a Brand may automatically publish and wish to post off-schedule content. For example, Retailer A has their content schedule to publish Monday and Wednesday, but the Brand wants a special promotion to be posted to Retailer A on a specific date, which falls on a Thursday. This special promotion content would be published to Retailer A's social media pages in addition to their regular content schedule, sometimes resulting in additional posts per day or week than defined in Retailer A's social media settings page.

Due to the system's intelligent level of analyzing the Brand content and custom matching each on-boarded Retailer's preferences, the service provider is able to deliver a unique and more natural social media strategy for each Retailer. The system will randomize content per Retailer and allows the Retailer to ensure that they will not receive the same content, on the same day or time, as a competing Retailer carrying the same or similar Brand products.

There are various stages where the service provider computing and data processing system is used to implement the automatic Brand content posting on Retailer social media sites. One of the primary components is a data storage component of the system where Brand digital assets are stored. The service provider receives digital content from a Brand and this content is categorized, labelled, and generally assigned metadata in the service provider system. The Brand may update this content as needed and may work with the service provider in organizing it. Another important component of the system is software for implementing scheduling of how and when the Brand content will be released to Retailer social media sites. The software shall also determine the auto-posting of content from the Brand content library to the social media sites. This may be characterized as auto-posting intelligence software. There is also Retailer settings and scheduling software that determines what content will be posted at a specific Retailer social media sites and when the posting will occur. Included on the Retailer side of the system, there may also be software for campaign management including automatic and manual subscriptions. In addition, there is software in the service provider system that can implement other business method features described above, such as scalable, wholesale redaction of postings from multiple Retailer social media sites. Another example is software for implementing the randomization feature when posting content to similar Retailers for similar content in the same or near the same regions. All these software modules and implementations may be executed on a data processing system as described below.

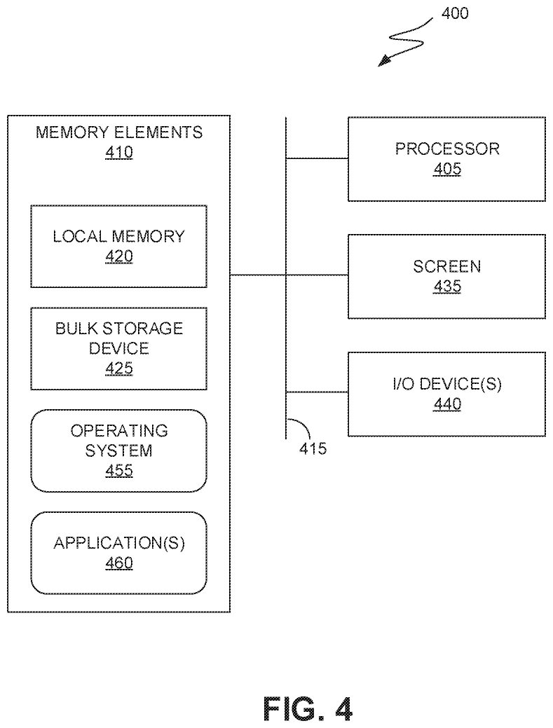

FIG. 4 is a block diagram of a data processing system 400 in accordance with one embodiment. System 400 may be used to implement any of a variety of systems and/or computing devices that include a processor and memory and that are capable of performing the operations described within this disclosure. It can be used to execute computer instructions to implement the logic flowcharts in FIGS. 1 to 3.

As pictured, system 400 includes at least one processor 405 coupled to memory elements 410 through a system bus 415 or other suitable circuitry such as an input/output (I/O) subsystem. System 400 stores program code within memory elements 410. Processor 405 executes the program code accessed from memory elements 410 via system bus 415. Memory elements 410 include one or more physical memory devices such as, for example, a local memory 420 and one or more bulk storage devices 425. Local memory 420 refers to random access memory (RAM) or other non-persistent memory device(s) generally used during actual execution of the program code. Bulk storage device 425 may be implemented as a hard disk drive (HDD), solid state drive (SSD), or other persistent data storage device. System 400 may also include one or more cache memories (not shown) that provide temporary storage of at least some program code in order to reduce the number of times program code must be retrieved from bulk storage device 425 during execution.

System 400 may be coupled to one or more I/O devices such as a screen 435 and one or more additional I/O device(s) 440. The I/O devices described herein may be coupled to system 400 either directly or through intervening I/O controllers. In one aspect, screen 435 may be implemented as a display device that is not touch sensitive. In another aspect, screen 435 may be implemented as a display device that is touch sensitive.

Examples of I/O device(s) 440 may include, but are not limited to, a universal remote control device, a keyboard, a mobile device, a pointing device, a controller, a camera, a speaker, and a microphone. In some cases, one or more of the I/O device(s) may be combined as in the case where a touch sensitive display device (e.g., a touchscreen) is used as screen 435. In that case, screen 435 may also implement a keyboard and a pointing device. Other examples of I/O devices 440 may include sensors. Exemplary sensors may include, but are not limited to, an accelerometer, a light sensor, touch screen sensors, one or more biometric sensors, a gyroscope, a compass, or the like.

I/O devices 440 may also include one or more network adapter(s). A network adapter is a communication circuit configured to establish wired and/or wireless communication links with other devices. The communication links may be established over a network or as peer-to-peer communication links. Accordingly, network adapters enable system 400 to become coupled to other systems, computer systems, remote printers, and/or remote storage devices, such as remote servers storing content. Examples of network adapter(s) may include, but are not limited to, modems, cable modems, Ethernet cards, wireless transceivers, whether short and/or long range wireless transceivers (e.g., cellular transceivers, 802.11x (Wi-Fi™) compatible transceivers, Bluetooth® compatible transceivers, and the like).

As pictured in FIG. 4, memory elements 410 may store an operating system 455 and one or more application(s) 460, such as applications for translating symbols and zero-amplitude time durations and symbol mapping tables. It may also store software for segmenting or breaking a message (to be transmitted) into pieces or segments that can be represented by symbols. In one aspect, operating system 455 and application(s) 460, being implemented in the form of executable program code, are executed by system 400 and, more particularly, by processor 405. As such, operating system 455 and application(s) 460 may be considered an integrated part of system 400. Operating system 455, application(s) 460, and any data items used, generated, and/or operated upon by system 400 are functional data structures that impart functionality when employed as part of system 400.

In one aspect, system 400 may be used to implement a computer, such as a personal computer, a server, or the like. Other examples of mobile computing devices may include, but are not limited to, a tablet computer, a mobile media device, a game console, a mobile internet device (MID), a laptop computer, a mobile appliance device, or the like.

System 400 may include fewer components than shown or additional components not illustrated in FIG. 4 depending upon the particular type of device that is implemented. In addition, the particular operating system and/or application(s) included may also vary according to device type as may the types of network adapter(s) included. Further, one or more of the illustrative components may be incorporated into, or otherwise form a portion of, another component. For example, a processor may include at least some memory.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. A method of posting digital content to a service providers web page created by a entity and at least one retailer entity independent of said brand entity accessing said digital content on said service providers web page and said at least one retailer entity having a social media web page which sells at least one product sold by said brand entity, and said retailer entity issuing a time dependent token that identifies and allows said at least one retailer entity web page access to said service providers web page and said token providing security of said digital content and access to said digital content for the specified time specified by the said retailer entity, the method comprising:
drafting a schedule for releasing digital content promoting at least one product by said brand entity;
updating said digital content as needed;
storing said digital content on said service providers web page,
creating a retailer-oriented communication including a link for a brand program sign-up page for use by the retailer entity and transmitting the communication using said token to the retailer entity;
said retailer entity using said token and selecting parameters relating to digital content type to be posted to the retailer social media web page;
selecting parameters relating to frequency and timing of posting of digital content to the retailer social media web page; and
posting the digital content to the social media web page, said posting performed by the brand entity using said digital content on said service provider web page, wherein the retailer entity performs no actions for the posting of the digital content to occur.

2. A method as recited in claim 1 wherein the posting of the digital content to the social media web page of the retailer entity is under the control of the brand entity with the assistance of the computing system operated by the said service provider.

3. A method as recited in claim 1 wherein the digital content of said at least one retailer entity social media web page is posted from said service provider web page with respect to at least one of timing of posting or specific digital assets identified by said time dependent token to said at least one retailer entity.

4. A method as recited in claim 1 further comprising:
enabling widespread redaction by a brand entity of a posting from at least one retailer social media web page, said redaction performed by an operation with the computing system provided by the said service provider, wherein an audit is performed on the multiple retailer entities who have the posting on social media web pages.

5. A method of disseminating digital content from a brand entity to at least one retailer entity and said at least one retailer entity issuing a token that allows said at least one retailer entity to access a service providers web page and said token providing security of said digital content and said token providing security of said digital content and access to said digital content for the specified time of the token, the method comprising:
collecting the digital content from the source entity, wherein the source has a relationship with said service provider;
storing the content in a digital library under control of said service provider;
receiving settings from the at least one retailer entity, wherein settings determine what type of content the at least one retailer entity wants and how the content will be disseminated; and
transmitting the content and said token to plurality of online web pages under control of the at least one retailer entity, wherein the content is posted to the plurality of online web page in a manner determined by the settings, and wherein the content is posted automatically and requires no manual intervention by the at least one retailer entity.
